(19) United States
(12) Patent Application Publication
(10) Pub. No.: US 2002/0184611 A1
(43) Pub. Date: Dec. 5, 2002

(54) Design system and method having improved display of code

(75) Inventor: Edward B. Endejan, Gurnee, IL (US)

Correspondence Address: Steven C. Becker, FOLEY & LARDNER, Firstar Center, 777 East Wisconsin Avenue, Milwaukee, WI, 53202-5367, US

(73) Assignee: Palm, Inc.

(21) Appl. No.: 09/870,308

(22) Filed: May 30, 2001

(51) Int. Cl. G06F 9/44

(52) U.S. Cl. 717/113; 717/124

(57) ABSTRACT

A design system comprises an editor configured to display segments of code. The segments of code comprise an active segment of code and an inactive segment of code. The editor is configured to display the active segment of code in a first display format and the inactive segment of code in a second display format different than the first display format.

### BACKGROUND OF THE DISCLOSURE

Many design systems are available to assist software and systems developers in designing programs. For example, integrated development environments (IDEs) typically provide an on-screen editor, compiler, linker and debugger, or some combination thereof, in a single software package. The software is operable on any number of computer systems, such as desktop or mainframe computers, and provides a convenient environment in which programmers can design, construct, and verify programs.

When reviewing lines of code on-screen, confusion can arise from the large number of lines of code, various conditional statements, complex subroutine calls, etc. Indentation, comments, and code organization have helped to reduce confusion. Also, some IDEs use color and font to differentiate programming language keywords, variables, comments, etc. Even some stand-alone editors allow for syntax highlighting (i.e. keywords). However, further improvements are needed.

One area of the IDE that can be improved is in the use of pre-processor directives for conditional compilation. Pre-processor directives of this variety are used to identify lines of code as being active or inactive, typically after a compilation step. Some compilers support command line parameters to save files from the interim steps of the compilation process. The developer then verifies the active lines of code only. If an error is found in the active lines of code, the programmer must return to the complete listing of code to make the change. One drawback of this system is that, in order to make a change to the code, the programmer must attempt to match up the line of code in the active code listing with the line of code in the complete code listing. This can be tedious and is, in any event, rather inconvenient. For this reason, this process is typically only performed when a problem is encountered, and then only when other methods of identifying the problem have been exhausted. Therefore, this process is not a normal part of code development.

Accordingly, what is needed is a design system and method having an improved display of code. Further, what is needed is a design system and method that reduces confusion when viewing segments of code. Further still, what is needed is a design system and method that automatically updates the display of code segments in response to code changes.

The teachings hereinbelow extend to those embodiments which fall within the scope of the appended claims, regardless of whether they accomplish one or more of the above-mentioned needs.

### SUMMARY OF EXEMPLARY EMBODIMENTS

According to one exemplary embodiment, a design system includes an editor configured to display segments of code. The segments of code include an active segment of code and an inactive segment of code. The editor displays the active segment of code in a first display format and the inactive segment of code in a second display format different than the first display format.

According to another exemplary embodiment, a method of displaying segments of source code in an integrated development environment includes distinguishing inactive segments of the source code and active segments of the source code, and displaying the active segments of the source code in a first display format and the inactive segments of the source code in a second display format different than the first display format.

According to yet another exemplary embodiment, a design system includes a means for distinguishing active segments of code from inactive segments of code and a means for displaying the active segments of code in a first display format and for displaying inactive segments of code in a second display format.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a schematic block diagram of a design system, according to an exemplary embodiment;

FIG. 2 is a set of code segments displayed on the display of the design system of FIG. 1 prior to compilation of pre-processor directives, according to an exemplary embodiment;

FIG. 3 is a set of code segments displayed on the display of the design system of FIG. 1 after compilation of pre-processor directives, according to an exemplary embodiment; and

FIG. 4 is a flow chart of a method having improved display of code, according to an exemplary embodiment.

### DETAILED DESCRIPTION OF EXEMPLARY EMBODIMENTS

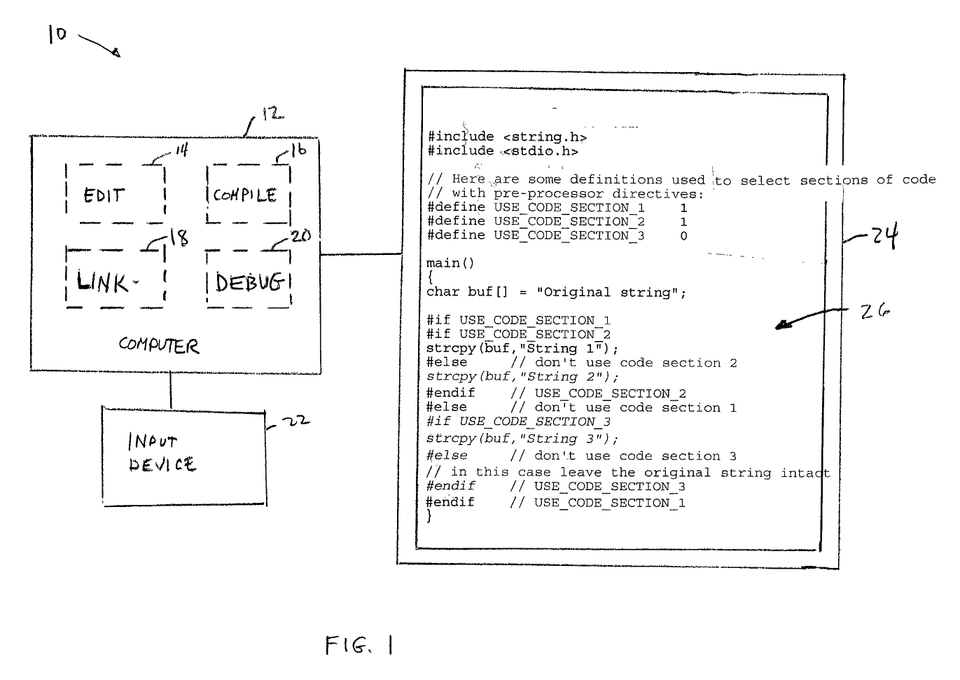

Referring first to FIG. 1, a design system 10 is shown as an integrated development environment (IDE) in this exemplary embodiment. Alternatively, design system 10 may be other types of design systems, typically for designing software, hardware models, or other systems, including stand-alone editors, etc. The improved system and method disclosed in the various embodiments herein are operable on any of a number of design systems, such as IDEs including Code Warrior, manufactured by Metrowerks, a Motorola, Inc. company, and Visual Studio, manufactured by Microsoft Corp.

Design system 10 includes a computer 12 configured with software and hardware for operating the design system and method. For example, a desktop computer utilizing an Intel x86 architecture microprocessor may be used along with an operating system, such as DOS, Windows, Linux, etc. and an application program. Computer 12 is operable to run various design and development tools, including one or more of an editor 14, a compiler 16, a linker 18, and a debugger 20. Tools 14-20 may be operable on one or more software languages, such as, C, C++, Pascal, Fortran, assembly, and other high- and low-level software programming languages. In this exemplary embodiment, a C-based programming language is illustrated.

Design system 10 further includes one or more input devices 22 and displays 24 coupled to computer 12. Input devices 22 may be one or more of a keyboard, mouse, voice-recognition device, touch pad, touch screen, or other input devices configured to receive segments of software code and other operator inputs from a programmer. Input device 22 may further be a disk drive, network connection, or other device for receiving segments of software code and/or other data from a memory or other computing device. Display 24 is preferably a full-color display, such as a cathode ray tube (CRT), a liquid crystal display (LCD), or other displays. Alternatively, display 24 may be monochromic or black-and-white.

Design system 10 is configured to operate editor 14 to receive segments of code, such as, characters, words, lines, etc., to store the segments of code in volatile or non-volatile memory, and to display the segments of code on display 24 for the convenience of a developer. Editor 14 may be a textual, graphical, or other type of editor.

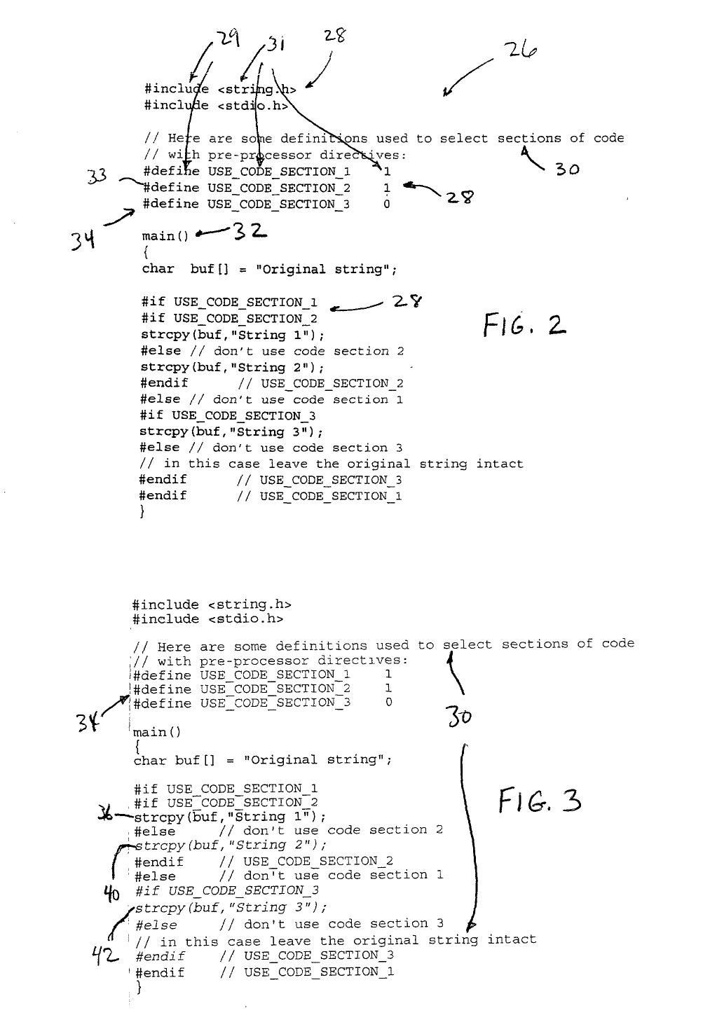

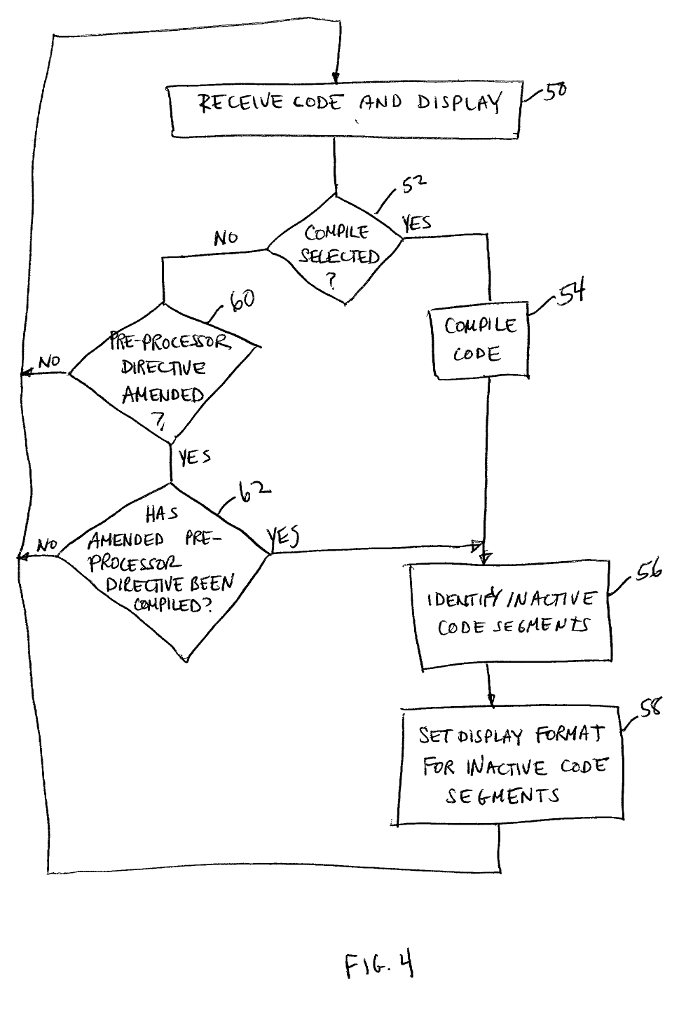

Design system 10 is further configured to compile and link the segments of code that have been entered, and to provide a debug tool 20 to allow the programmer to verify or debug the code. A plurality of code segments 26 are illustrated in FIG. 1 and will be described in greater detail with reference to FIGS. 2 and 3.

Referring now to FIG. 2, code segments 26 include preprocessor directives 28, comments 30, and other code 32, such as, functions, etc. Pre-processor directives are illustrated in this example by using the ‘#’ symbol as a prefix, and include #include, #define, #if, #else, #endif, etc. Other design systems, IDEs, or programming languages may utilize other symbols to identify preprocessor directives. Comments 30 are indicated in this example by the ‘//’ symbol combination. Comments 30 may be indicated in this or other programming languages by the use of other symbols, or combinations thereof.

According to one advantageous aspect of this exemplary embodiment, various display formats are used to highlight different types of code segments. The display format may include color, gray scale, highlighting, lowlighting, background color, font, underlining, bolding, italics, blinking text, text which changes display format when a cursor is placed over the text, etc. The display format may include a single display format (e.g. color) or a combination of display formats (e.g. color and gray scale). In this example, pre-processor directives 28 include a command 29 and operands 31. Commands 29 are displayed in the color blue and operands 31 are displayed in a different color, such as black or red. Comments 30 are provided in a gray scale that is lighter in gray scale than surrounding text. Furthermore, commands of pre-processor directives which affect whether portions of code are active or inactive (such as command 33) are provided in the color red while commands which do not affect whether segments of code are active or inactive are provided in the color black. Numerous combinations of display formats for segments are contemplated, which are based on the function placement, or another characteristic of the code segments.

Design system 10 is configured to distinguish inactive segments of code from active segments of code, and to display the inactive segments of code in a different display format than the active segments of code (i.e. at least one characteristic or feature of the first and second display formats is different, such as color, font, gray scale, etc.). A code segment is inactive if a conditional statement or conditional compilation directive in the source code prevents the code segment from being executed in the executable form of the code under any condition or set of conditions. Active code segments are code segments in the source code which may be executed in the executable form of the code, even though their execution may depend on certain possible conditions. The conditional statement may include one or more of if, else, nested forms of if and else, for, while, etc. The conditional compilation directive may include one or more pre-processor directives, such as, a #define directive, a #undef directive, a #if directive, a #ifdef directive, a #ifndef directive, a #else directive, a #elif directive, a #endif directive, etc. Other conditional statements and conditional compilation directives are possible and may depend upon the programming language being used.

For example, the code segment:

if(false){dead_code( );};

is a conditional statement which identifies dead_code( ) as an inactive code segment. Compiler 16 or linker 18 is configured to strip out this “dead code” from the resulting output files or executable code to reduce code size. Design system 10 is configured to display dead_code( ) in a different display format, such as, a lowlighted or gray display format, than surrounding active code, which may be displayed in a typical black display format. This display feature is very convenient to the programmer. Alternatively, the entire statement if(false){dead_code( );};, or some portion thereof, may be displayed in the lowlighted or gray display format. The inactive code segment may be displayed in a different display format after a first compilation or linking of the code, or may alternatively be displayed in the different display format in real time, as the code is being entered into editor 14 by the programmer.

Referring to FIG. 2 and FIG. 3, an exemplary embodiment using pre-processor directives will now be described. A set of preprocessor directives 34, shown as #define directives, indicate which code sections are to be used by associating the term USE_CODE_SECTION_{—}1 and USE_CODE_SECTION_{—}2 with the binary value of one and by defining the term USE_CODE_SECTION_{—}3 with the binary value of zero. In this manner, different versions of software may be enabled and disabled easily at the pre-processor directives. In the example shown in FIG. 2, code sections 1 and 2 are used in the sample function main( ). However, it is not readily visible to a programmer based on the display in FIG. 2 which of the string copy (strcpy) code segments of the function main( ) are active and which are inactive based on pre-processor directives 34.

Accordingly, referring to FIG. 3, and in accordance with an advantageous aspect of this exemplary embodiment, editor 14 displays active code segment 36 in a different display format than inactive code segments 40 and 42. In particular, inactive code segments 40 and 42 have a visually different gray scale, namely a lighter gray scale, than active code segment 36. Alternatively, different colors, or other display formats may be used.

In one alternative, display formats are used to identify classes of code segments. For example, ordinary source code and keywords can be classified in one class, and comments and inactive code can be classified in a second class. The first class is displayed with a standard gray scale, with ordinary source code in black and keywords in blue, and the second class is displayed with a low-lighting gray scale (i.e. visibly lighter than the first class of code segments), with comments in gray and inactive code in light blue. According to a further feature, a display format for one class of code segments overrides a display format for another class of code segments. Thus, the word “if” is a keyword, but if the word “if” is in a comment, it would be displayed in gray, not blue, because the second display format overrides the first in this exemplary embodiment.

According to a further advantageous feature, editor 14 is configured to display inactive code segments 40 and 42 and comments 30 with at least one same display format, to even greater simplify the reading of the code segments. For example, both inactive code 40 and 42 and comments 30 can be displayed in low lighting, even though the colors of the two display formats may be different.

According to yet another advantageous feature, design system 10 is configured to automatically switch the display format of active code segment 36 to an inactive display format, as shown by the display formats of inactive code segments 40 and 42, in response to receiving a change to the set of pre-processor directives 34. Further, editor 14 is configured to automatically switch the display format of one or more of inactive code segments 40 and 42 from the inactive display format to the active display format in response to a change to the set of pre-processor directives 34. This change may happen in real time and without the need for an additional compilation step or other operator input. Pre-processor directives 34 need not be in the same source code file for this feature to work, but could instead be located in one or more other files included by reference, as is indicated by the pre-processor directive “#include”.

Thus, it can be seen that code segments that are not active due to pre-processor directives or other conditional statements in the source code can be clearly identified to the programmer to reduce the confusion associated with studying large amounts of complex code. One or more portions of design system 10 can be integrated, for example as an optional feature, with existing IDEs or other design systems in a simple manner.

Referring now to FIG. 4, several exemplary methods of displaying segments of source code in a design system will now be described. At step 50, design system 10 is configured to receive code and display code, typically entered by a programmer via a keyboard, mouse, etc. or loaded from a disk or other network or storage device. Editor 14 is configured to provide a work environment in which the code is entered and displayed. If the programmer selects “compile” at step 52, for example via a dropdown menu or via a hotkey in editor 14, compiler 16 begins compiling and/or linking (via linker 18) the code (step 54). Based on the results of step 54, design system 10 identifies code segments which are inactive and/or active at step 56, as described in exemplary form with reference to FIGS. 2 and 3 hereinabove.

In some IDEs, pre-processor directives are processed prior to compilation by a pre-processor program. In an alternative embodiment, step 52 determines whether pre-processor directives have been processed and step 54 processes the pre-processor directives.

Once code segments have been distinguished between inactive code segments and active code segments, design system 10 sets the display format for the inactive code segments (step 58), typically by changing their display formats from a standard, active display format (e.g. black text on a white background) to an inactive display format (e.g. gray text on a white background). Programming returns to step 50 where additional code may be received and displayed.

If, during editing of the code, the programmer amends a pre-processor directive (step 60), the method proceeds to step 62 to determine if the pre-processor directive has already been compiled. If not, the method returns to step 50 without adjusting the display format of the pre-processor directive. If the pre-processor directive has already been compiled, the method proceeds to step 56 to identify inactive and/or active code segments and to step 58 to set the display format for at least the inactive code segments. In this way, as the programmer is editing the source code in editor 14, when a pre-processor directive is amended, design system 10 automatically reconfigures the display formats of all active and inactive code based on the pre-processor directive. Thus, a change of #define USE_CODE_SECTION_{—}1 from a logical zero to a logical one results in a change to the display format of any code which has changed from active to inactive, or vice-versa, based on the amended pre-processor directive.

In the embodiment of FIG. 4, if the pre-processor directive has not already been compiled, a change to the pre-processor directive will not automatically be reflected in a change in display format of active and inactive code segments. In an alternate embodiment, design system 10 is configured to change the display format of active and inactive code segments in response to a change in a pre-processor directive, even if the pre-processor directive has not yet been compiled.

As a further alternative, step 60 may be amended to monitor a change in any conditional statement, and design system 10 may be configured to change the display format of inactive and active segments of code automatically based on the change in conditional statement.

According to yet another alternative embodiment, design system 10 may include the use of targets to select portions of code as active and inactive. Targets define sets of #defines or other preprocessor directives for different versions of code (e.g. target A for a debugging version of code and target B for a release version of code). Compiler 16 and/or linker 18 are configured to generate different output files (e.g. object code, source code, etc.) based on the target selected. In this embodiment, selecting target A or B (e.g. from a drop-down menu) causes design system 10 to display active and inactive code segments (as defined by the target selected) in different display formats.

While the exemplary embodiments illustrated in the FIGS. and described above are presently preferred, it should be understood that these embodiments are offered by way of example only. For example, the exemplary systems and methods disclosed herein may be applied to other conditional statements in other programming languages that distinguish inactive code segments from active code segments. Accordingly, the present invention is not limited to a particular embodiment, but extends to various modifications that nevertheless fall within the scope of the appended claims.

What is claimed is:

1. A design system comprising an editor configured to display segments of code, the segments of code comprising an active segment of code and an inactive segment of code, wherein the editor is configured to display the active segment of code in a first display format and the inactive segment of code in a second display format different than the first display format.

2. The design system of claim 1, wherein the segments of code further comprise a comment, wherein the editor is further configured to display the comment and the inactive segments of code with at least one same display format.

3. The design system of claim 2, wherein the at least one same display format is a visibly different gray scale from the first display format.

4. The design system of claim 3, wherein the inactive segment of code has at least one different display format than the comment.

5. The design system of claim 1, further comprising a preprocessor directive, wherein the pre-processor directive defines segments of code as active or inactive.

6. The design system of claim 5, wherein the editor is configured to automatically switch the display format of one of the segments of code from the first display format to the second display format in response to a change to the pre-processor directive.

7. The design system of claim 5, further comprising a compiler configured to interpret the pre-processor directive, a linker and a debugger.

8. The design system of claim 5, wherein the preprocessor directive is selected from the group consisting of a #define directive, a #undef directive, a #if directive, a #ifdef directive, a #ifndef directive, a #else directive, a #elif directive, and a #endif directive.

9. A method of displaying segments of source code in an integrated development environment, comprising:
distinguishing inactive segments of the source code from active segments of the source code; and
displaying the active segments of the source code in a first display format and the inactive segments of the source code in a second display format different than the first display format.

10. The method of claim 9, further comprising:
receiving a change to the source code which changes one of the active segments of the source code to an inactive segment of the source code; and
changing the display format of the one of the active segments of the source code from the first display format to the second display format.

11. The method of claim 9, wherein the step of distinguishing includes applying a pre-processor directive to the source code to determine the active and inactive segments.

12. The method of claim 11, wherein the first display format includes a first color or font and the second display format includes a second color or font.

13. The method of claim 9, further comprising displaying comments and inactive code segments with at least one same display format.

14. A design system, comprising:
means for distinguishing active segments of code from inactive segments of code; and
means for displaying the active segments of code in a first display format and for displaying inactive segments of code in a second display format.

15. The design system of claim 14, wherein the means for displaying displays comments and inactive code segments with at least one same display format.

16. The design system of claim 14, wherein the first display format and the second display format have visibly different gray scales.

17. The design system of claim 16, wherein the second display format has a lighter gray scale than the first display format.

18. The design system of claim 14, wherein the means for distinguishing includes applying a pre-processor directive to distinguish between active and inactive segments of code.

19. The design system of claim 14, further comprising means for compiling the segments of code.

20. The design system of claim 19, wherein the means for displaying automatically switches the display format of one of the segments of code from the first display format to the second display format in response to a change to a pre-processor directive.
